(19) United States
(12) Patent Application Publication
(10) Pub. No.: US 2019/0294443 A1
(43) Pub. Date: Sep. 26, 2019

(54) PROVIDING EARLY PIPELINE OPTIMIZATION OF CONDITIONAL INSTRUCTIONS IN PROCESSOR-BASED SYSTEMS

(71) Applicant: QUALCOMM Incorporated, San Diego, CA (US)

(72) Inventors: Sandeep Suresh Navada, San Jose, CA (US); Michael Scott McIlvaine, Raleigh, NC (US); Rodney Wayne Smith, Raleigh, NC (US); Robert Douglas Clancy, Cary, NC (US); Yusuf Cagatay Tekmen, Raleigh, NC (US); Niket Choudhary, Bangalore (IN); Daren Eugene Streett, Cary, NC (US); Richard Doing, Raleigh, NC (US); Ankita Upreti, Morrisville, NC (US)

(21) Appl. No.: 15/926,429

(22) Filed: Mar. 20, 2018

(51) Int. Cl. G06F 9/38

(52) U.S. Cl. CPC G06F 9/3865; G06F 9/3812; G06F 9/3806

(57) ABSTRACT

Providing early pipeline optimization of conditional instructions in processor-based systems is disclosed. In one aspect, an instruction pipeline of a processor-based system detects a mispredicted branch (i.e., following a misprediction of a condition associated with a speculatively executed conditional branch instruction), and records a current state of one or more condition flags as a condition flags snapshot. After a pipeline flush is initiated and a corrected fetch path is restarted, an instruction decode stage of the instruction pipeline uses the condition flags snapshot to apply optimizations to conditional instructions detected within the corrected fetch path. According to some aspects, the condition flags snapshot is subsequently invalidated upon encountering a condition-flag-writing instruction within the corrected fetch path. In this manner, the condition flags snapshot enables non-speculative (with respect to the corrected fetch path) resolution of conditional instructions earlier within the instruction pipeline, thus conserving system resources and improving processor performance.

### BACKGROUND

### I. Field of the Disclosure

The technology of the disclosure relates generally to pipeline optimizations for processor-based systems, and, in particular, to providing early pipeline optimization of conditional instructions.

### II. Background

“Conditional instructions,” as used herein, refer to computer-executable instructions that are executed only if a specified condition is met. A conditional instruction may be a conditional branch instruction (which allows program control within an executing computer program to be transferred in response to an asserted condition evaluating as true), or may be a conditional non-branch instruction (the execution of which may vary based on whether a specified condition associated with the instruction evaluates to true). In some computer architectures, such as the Arm® architecture, the outcome of a conditional instruction may be determined by examining a state of condition flags that are maintained by a processor, and that may be set based on the results of previously executed instructions. For example, in the Arm® architecture, four condition flags are represented by bits stored in the Application Processor Status Register (APSR), and are referred to as an N (negative) condition flag, a Z (zero) condition flag, a C (carry or unsigned overflow) condition flag, and a V (signed overflow) condition flag.

To improve processor performance, the outcome of a condition associated with a conditional instruction may be predicted by the processor, and subsequent instructions may be speculatively fetched based on the predicted outcome. For instance, the next instruction following a conditional branch instruction may be predicted and speculatively fetched based on the predicted outcome of a condition associated with the conditional branch instruction. Similarly, a conditional non-branch instruction may be speculatively executed (or speculatively not executed) based on a predicted outcome of the conditional non-branch instruction's specified condition.

However, the actual determination as to whether a predicted outcome is correct or not is unknown until the conditional instruction is actually executed by an execution stage, which may be one of the later stages of a conventional instruction pipeline. In particular, a misprediction of a conditional branch instruction that is dependent on the condition flags may require a flush of the instruction pipeline to remove instructions that were wrongly fetched based on the misprediction, followed by a fetch of instructions based on the actual outcome of the conditional branch instruction. However, such a pipeline flush results in a loss of the condition flags, which otherwise could be useful for optimizing the execution of instructions fetched following the pipeline flush (e.g., by performing an early determination of subsequently fetched conditional instructions). Consequently, any subsequently fetched conditional instructions remain subject to the latency incurred in correcting the mispredicted branch.

### SUMMARY OF THE DISCLOSURE

Aspects disclosed in the detailed description include providing early pipeline optimization of conditional instructions in processor-based systems. In this regard, in one aspect, a processor-based system provides an instruction pipeline that comprises, among other stages, one or more instruction fetch stages, an instruction decode stage, one or more execution stages, and a register writeback stage. Upon detecting a mispredicted branch within the instruction pipeline (i.e., following a misprediction of a condition associated with a speculatively executed conditional branch instruction that is dependent on one or more condition flags), a current state of one or more condition flags is recorded as a condition flags snapshot, which is provided to the one or more instruction fetch stages of the instruction pipeline. After a pipeline flush is initiated and a corrected fetch path is restarted, the instruction decode stage of the instruction pipeline uses the condition flags snapshot to apply an optimization to conditional instructions encountered within the corrected fetch path. For example, in some aspects, the condition flags snapshot may be used to determine, definitively and non-speculatively, whether a conditional branch instruction will be taken. If so, a non-speculative fetch address for the target instruction of the conditional branch instruction is provided to the one or more instruction fetch stages, and the conditional branch instruction is replaced with a NOP (no operation) instruction. Similarly, the condition flags snapshot may be used to non-speculatively determine whether and/or how a conditional non-branch instruction will be executed, and/or may be used to apply other optimizations to the conditional non-branch instruction. According to some aspects, the condition flags snapshot is invalidated upon encountering a condition-flag-writing instruction within the corrected fetch path. Processing then continues in conventional fashion until a next mispredicted branch is detected.

In another aspect, a processor-based system for providing early pipeline optimization of conditional instructions is provided. The processor-based system comprises an instruction pipeline comprising an instruction fetch stage, an instruction decode stage, an execution stage, and a register writeback stage. The execution stage of the instruction pipeline is configured to detect a mispredicted branch within an original fetch path. Responsive to the mispredicted branch, the execution stage initiates a pipeline flush to begin a corrected fetch path. The register writeback stage of the instruction pipeline is configured to, responsive to the mispredicted branch, provide a condition flags snapshot comprising a current state of one or more condition flags to the instruction fetch stage of the instruction pipeline. The instruction decode stage of the instruction pipeline is configured to detect a conditional instruction within the corrected fetch path, and apply an optimization to the conditional instruction based on the condition flags snapshot.

In another aspect, a processor-based system for providing early pipeline optimization of conditional instructions is provided. The processor-based system comprises a means for detecting a mispredicted branch within an original fetch path of an instruction pipeline of the processor-based system. The processor-based system further comprises a means for initiating a pipeline flush to begin a corrected fetch path, responsive to the mispredicted branch. The processor-based system also comprises a means for providing a condition flags snapshot comprising a current state of one or more condition flags to an instruction fetch stage of the instruction pipeline. The processor-based system additionally comprises a means for detecting a conditional instruction within the corrected fetch path. The processor-based system further comprises a means for applying an optimization to the conditional instruction based on the condition flags snapshot.

In another aspect, a method for providing early pipeline optimization of conditional instructions is provided. The method comprises detecting, by an execution stage of an instruction pipeline, a mispredicted branch within an original fetch path. The method further comprises, responsive to the mispredicted branch, initiating, by the execution stage, a pipeline flush to begin a corrected fetch path. The method also comprises providing, by a register writeback stage of the instruction pipeline, a condition flags snapshot comprising a current state of one or more condition flags to an instruction fetch stage of the instruction pipeline. The method additionally comprises detecting, by an instruction decode stage of the instruction pipeline, a conditional instruction within the corrected fetch path. The method further comprises applying, by the instruction decode stage, an optimization to the conditional instruction based on the condition flags snapshot.

In another aspect, a non-transitory computer-readable medium is provided. The non-transitory computer-readable medium stores thereon computer-readable instructions to cause a processor to detect a mispredicted branch within an original fetch path of an instruction pipeline of the processor. The computer-readable instructions further cause the processor to, responsive to the mispredicted branch, initiate a pipeline flush to begin a corrected fetch path. The computer-readable instructions also cause the processor to provide a condition flags snapshot comprising a current state of one or more condition flags to an instruction fetch stage of the instruction pipeline. The computer-readable instructions additionally cause the processor to detect a conditional instruction within the corrected fetch path. The computer-readable instructions further cause the processor to apply an optimization to the conditional instruction based on the condition flags snapshot.

### BRIEF DESCRIPTION OF THE FIGURES

FIG. 1 is a block diagram of an exemplary processor-based system including an instruction pipeline configured to provide early pipeline optimization of conditional instructions;

FIG. 2 is a block diagram illustrating an original fetch path in which a mispredicted branch is detected, and a corrected fetch path in which a condition flags snapshot is used to apply optimizations to a conditional instruction;

FIGS. 3A-3C are block diagrams illustrating in greater detail exemplary optimizations that may be applied to conditional branch instructions and conditional non-branch instructions according to some aspects;

FIGS. 4A and 4B are flowcharts illustrating an exemplary process for providing early pipeline optimization of conditional instructions;

FIG. 5 is a flowchart illustrating exemplary operations for applying optimizations to conditional branch instructions according to some aspects;

FIG. 6 is a flowchart illustrating exemplary operations for applying optimizations to conditional non-branch instructions according to some aspects; and

FIG. 7 is a block diagram of an exemplary processor-based system that can include the instruction pipeline of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

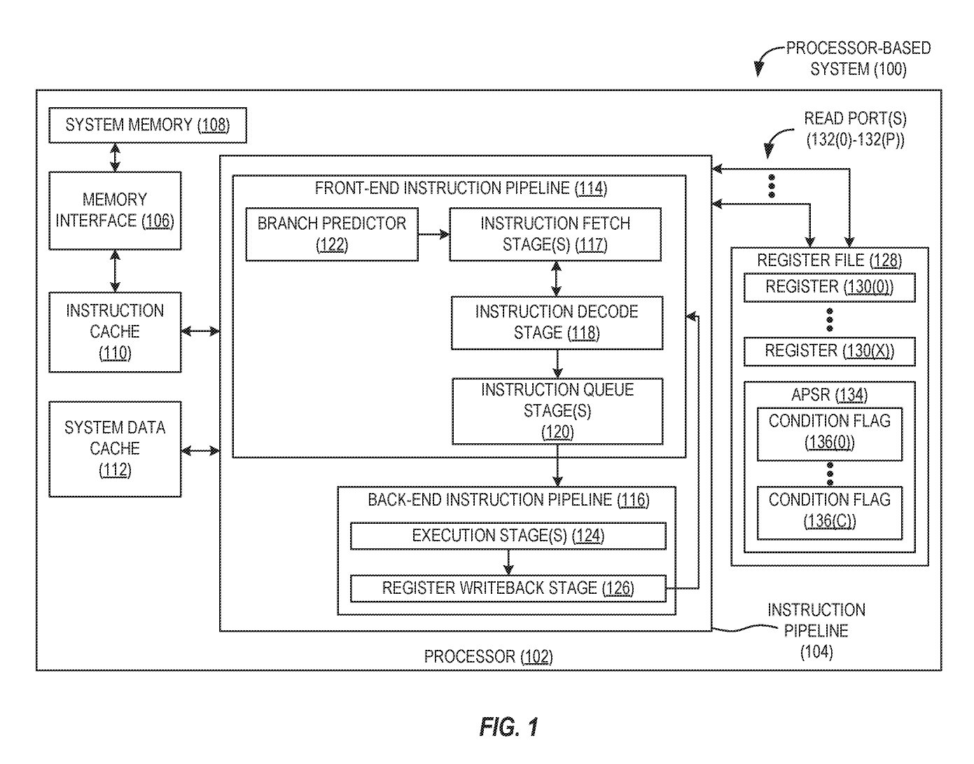

Aspects disclosed in the detailed description include early pipeline optimization of conditional instructions. Accordingly, in this regard, FIG. 1 is a block diagram of an exemplary processor-based system 100 comprising a processor 102 providing an instruction pipeline 104 configured for early optimization of conditional instructions, as disclosed herein. The processor 102 includes a memory interface 106, through which a system memory 108 may be accessed. In some aspects, the system memory 108 may comprise double-rate dynamic random access memory (DRAM) (DDR), as a non-limiting example. The processor 102 further includes an instruction cache 110, and a system data cache 112. The system data cache 112, in some aspects, may comprise a Level 1 (L1) data cache. The processor 102 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages.

In the example of FIG. 1, the instruction pipeline 104 of the processor 102 is subdivided into a front-end instruction pipeline 114 and a back-end instruction pipeline 116. As used herein, “front-end instruction pipeline 114” may refer collectively to a group of pipeline stages that are conventionally located at the “beginning” of the instruction pipeline 104, and that provide fetching, decoding, and/or instruction queueing functionality. In this regard, the front-end instruction pipeline 114 of FIG. 1 includes one or more instruction fetch stages 117, an instruction decode stage 118, and one or more instruction queue stages 120. As non-limiting examples, the one or more instruction fetch stages 117 may include F1, F2, and/or F3 fetch/decode stages (not shown). The front-end instruction pipeline 114 may further provide a branch predictor 122 for generating branch predictions for conditional branch instructions, and providing predicted fetch addresses to the one or more instruction fetch stages 117.

The term “back-end instruction pipeline 116” as used herein refers collectively to subsequent pipeline stages of the instruction pipeline 104 for issuing instructions for execution, for carrying out the actual execution of instructions, and/or for loading and/or storing data required by or produced by instruction execution. In the example of FIG. 1, the back-end instruction pipeline 116 comprises one or more execution stages 124 and a register writeback stage 126. It is to be understood that the stages 117, 118, 120 of the front-end instruction pipeline 114 and the stages 124, 126 of the back-end instruction pipeline 116 shown in FIG. 1 are provided for illustrative purposes only, and that other aspects of the processor 102 may contain additional or fewer pipeline stages than illustrated herein.

The processor 102 additionally includes a register file 128, which provides physical storage for a plurality of registers 130(0)-130(X) and which may be accessed via one or more read ports 132(0)-132(P). In some aspects, the registers 130(0)-130(X) may comprise one or more general purpose registers (GPRs), a program counter, and/or a link register. In the example of FIG. 1, the register file 128 also provides storage for an Application Process Status Register (“APSR”) 134, which provides a plurality of condition flags 136(0)-136(C). The condition flags 136(0)-136(C) according to some aspects may include an N (negative) condition flag, a Z (zero) condition flag, a C (carry or unsigned overflow) condition flag, and a V (signed overflow) condition flag. It is to be understood that some aspects may provide more, fewer, or different condition flags 136(0)-136(C) than those illustrated in FIG. 1.

In exemplary operation, the one or more instruction fetch stages 117 of the front-end instruction pipeline 114 of the instruction pipeline 104 fetch program instructions (not shown) from the instruction cache 110. Program instructions may be further decoded by the instruction decode stage 118 of the front-end instruction pipeline 114, and passed to the one or more instruction queue stages 120 pending issuance to the back-end instruction pipeline 116. After the program instructions are issued to the back-end instruction pipeline 116, the execution stage(s) 124 of the back-end instruction pipeline 116 execute the issued program instructions and retire the executed program instructions, and the register writeback stage 126 stores results of the executed instructions.

In some aspects, the one or more instruction fetch stages 117 of the front-end instruction pipeline 114 of the instruction pipeline 104 may fetch instructions based on a branch prediction provided by the branch predictor 122 for a conditional branch instruction. However, any mispredicted branches generated by the branch predictor 122 may not be detected until the conditional branch instruction is executed by the one or more execution stages 124 of the back-end instruction pipeline 116 of the instruction pipeline 104. By that point, additional subsequent instructions may have been erroneously fetched, and may have progressed to various stages within the instruction pipeline 104. For this reason, when a mispredicted branch is detected, the one or more execution stages 124 initiate a pipeline flush to clear the instruction pipeline 104 of previously fetched instructions, and the one or more instruction fetch stages 117 re-fetch the correct instructions following the conditional branch instruction. Such a pipeline flush results in a loss of the condition flags 136(0)-136(C), which otherwise could be useful for optimizing the execution of instructions fetched following the pipeline flush (e.g., by performing an early determination of subsequently fetched conditional instructions). As a result, any subsequently fetched conditional instructions remain subject to the latency incurred in correcting the mispredicted branch.

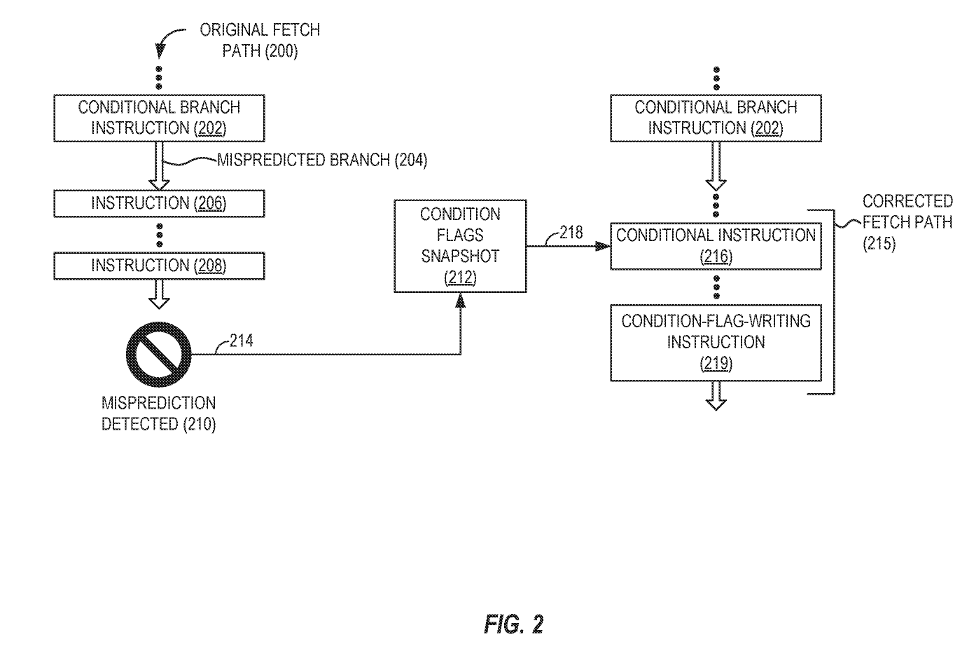

In this regard, the instruction pipeline 104 of the processor 102 of FIG. 1 is configured to generate a condition flags snapshot (not shown) storing the contents of the condition flags 136(0)-136(C) upon detection of a mispredicted branch of a branch instruction dependent on the condition flags 136(0)-136(C), and to employ the condition flags snapshot to optimize conditional instructions in the corrected fetch path early in the instruction pipeline 104. To better illustrate how the instruction pipeline 104 of FIG. 1 generates and employs the condition flags snapshot, FIG. 2 is provided. In FIG. 2, an original fetch path 200 illustrates a sequence of instructions fetched by the one or more instruction fetch stages 117 of the instruction pipeline 104 of FIG. 1 during the course of processing a program. Within the original fetch path 200, a conditional branch instruction 202, which is dependent on conditions flags such as the condition flags 136(0)-136(C) of FIG. 1, is fetched first. After the conditional branch instruction 202 is fetched, the branch predictor 122 of FIG. 1 erroneously predicts the outcome of the conditional branch instruction 202, which leads to a mispredicted branch 204 and the subsequent fetching of instructions 206 and 208 within the original fetch path 200.

As the conditional branch instruction 202 moves through the instruction pipeline 104 of FIG. 1, the one or more execution stages 124 of the instruction pipeline 104 detect that the conditional branch instruction 202 was mispredicted, as indicated by element 210 of FIG. 2. In response, the one or more execution stages 124 initiate a flush of the instruction pipeline 104 to flush the instructions 206 and 208 that were fetched subsequent to the conditional branch instruction 202. The register writeback stage 126 of the instruction pipeline 104 then generates a condition flags snapshot 212, as indicated by arrow 214. The condition flags snapshot 212 represents a record of the contents of the condition flags 136(0)-136(C) of FIG. 1 following execution of the conditional branch instruction 202 by the one or more execution stages 124 of the instruction pipeline 104. The condition flags snapshot 212 is then provided to the front-end instruction pipeline 114 of the instruction pipeline 104.

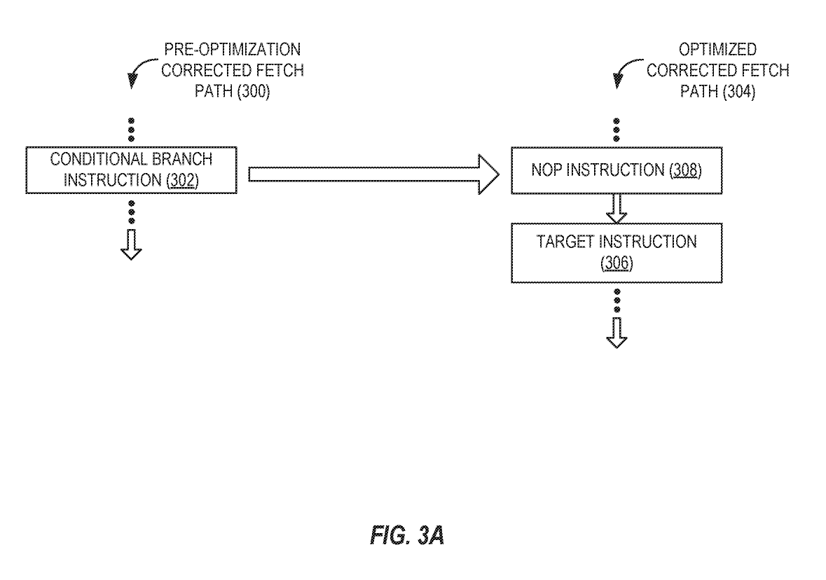

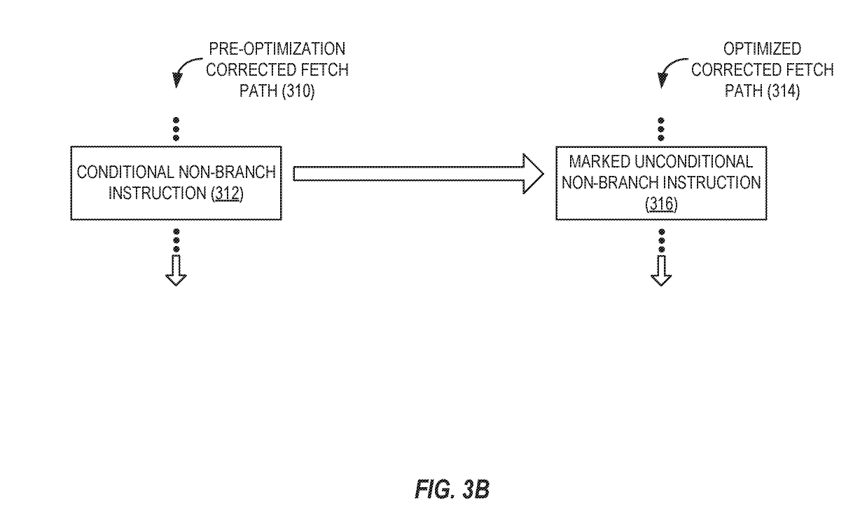

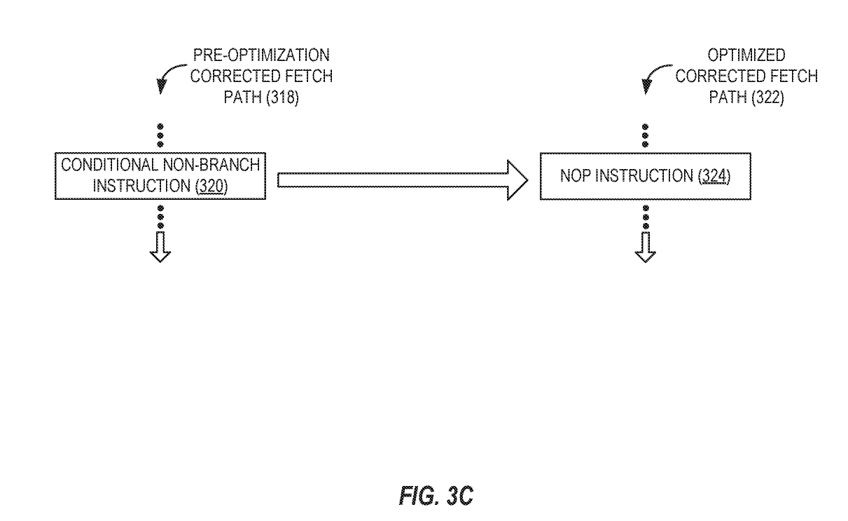

After the instruction pipeline 104 is flushed following the detection of the mispredicted branch 204, a corrected fetch path 215, including the subsequent instructions to which the conditional branch instruction 202 actually branched, is begun. In the example of FIG. 2, the corrected fetch path 215 includes a conditional instruction 216 (e.g., a conditional branch instruction or a conditional non-branch instruction) that is detected by the instruction decode stage 118 of the instruction pipeline 104 of FIG. 1. Upon detection of the conditional instruction 216 within the instruction pipeline 104, the instruction decode stage 118 performs an optimization on the conditional instruction 216 based on the condition flags snapshot 212, as indicated by arrow 218. Note that the condition flags snapshot 212 represents the known non-speculative state of the processor 102 (i.e., non-speculative with respect to the corrected fetch path 215) at the time the conditional branch instruction 202 was executed. Consequently, the instruction decode stage 118 is able to use the condition flags snapshot 212 to perform optimizations such as non-speculatively evaluating the condition associated with the conditional instruction 216 based on the condition flags snapshot 212, and modifying the corrected fetch path 215 accordingly. Examples of performing optimizations on conditional branch instructions and conditional non-branch instructions corresponding to the conditional instruction 216 are discussed in greater detail below with respect to FIGS. 3A-3C.

The condition flags snapshot 212 may continue to be used for optimization of additional conditional instructions within the corrected fetch path 215 until such time as the condition flags 136(0)-136(C) are modified by an instruction within the corrected fetch path 215 (at which point the condition flags snapshot 212 may no longer accurately represent the contents of the condition flags 136(0)-136(C)). Accordingly, the instruction decode stage 118 monitors the corrected fetch path 215 to detect the fetching of a condition-flag-writing instruction 219. Upon detecting the condition-flag-writing instruction 219 within the corrected fetch path 215, the instruction decode stage 118 invalidates the condition flags snapshot 212, and processing of fetched instructions resumes in conventional fashion until another mispredicted branch 204 is detected.

FIGS. 3A-3C illustrate in greater detail exemplary optimizations that may be applied to conditional branch instructions and conditional non-branch instructions within the front-end instruction pipeline 114 according to some aspects. FIG. 3A illustrates an exemplary optimization that may be performed for conditional branch instructions, while FIGS. 3B and 3C each illustrate an exemplary operation that may be performed for conditional non-branch instructions.

In FIG. 3A, a pre-optimization corrected fetch path 300, including a conditional branch instruction 302, is shown. It is to be understood that the pre-optimization corrected fetch path 300 in some aspects corresponds to the corrected fetch path 215 of FIG. 2 before an optimization is performed, while the conditional branch instruction 302 corresponds to the conditional instruction 216 of FIG. 2. In the example of FIG. 3A, the instruction decode stage 118 of FIG. 1 may perform an optimization of the conditional branch instruction 302 by using the condition flags snapshot 212 to non-speculatively determine whether or not the conditional branch instruction 302 will be taken (i.e., any prediction generated by the branch predictor 122 of FIG. 1 for the conditional branch instruction 302 is ignored). Based on this determination, the instruction decode stage 118 generates an optimized corrected fetch path 304 by identifying a target instruction 306 to which the conditional branch instruction 302 will branch, and forwarding a fetch address (not shown) for the target instruction 306 to the one or more instruction fetch stages 117 of FIG. 1. The instruction decode stage 118 also replaces the conditional branch instruction 302 within the optimized corrected fetch path 304 with a NOP (no operation) instruction 308. The optimized corrected fetch path 304 then continues through the instruction pipeline 104 in conventional fashion

In some aspects, the instruction decode stage 118 employs the condition flags snapshot 212 to perform an optimization on a conditional non-branch instruction to limit a number of the one or more read ports 132(0)-132(P) consumed by the conditional non-branch instruction. In this regard, FIG. 3B shows a pre-optimization corrected fetch path 310 (corresponding to the corrected fetch path 215 of FIG. 2 prior to optimization) that includes a conditional non-branch instruction 312. In the example of FIG. 3B, the instruction decode stage 118 generates an optimized corrected fetch path 314 including a marked unconditional non-branch instruction 316, which is marked to not consume a number of the one or more read ports 132(0)-132(P) based on the condition flags snapshot 212. As a non-limiting example, the conditional non-branch instruction 312 may comprise the ARM instruction “CSEL Wd, Wn, Wm, cond,” which is a conditional select instruction that reads a value from register “Wn” or register “Wm” depending on an evaluation of the condition “cond,” and stores the read value in a destination register “Wd.” Based on the condition flags snapshot 212, the instruction decode stage 118 may non-speculatively determine which of the registers “Wn” or “Wm” will be read by the conditional non-branch instruction 312, and may generate the marked unconditional non-branch instruction 316 accordingly.

The instruction decode stage 118 according to some aspects may also employ the condition flags snapshot 212 to non-speculatively determine whether or not a conditional non-branch instruction will be executed at all. In this regard, a pre-optimization corrected fetch path 318, such as the corrected fetch path 215 of FIG. 2, includes a conditional non-branch instruction 320 that the instruction decode stage 118 determines will not be executed, based on the condition flags snapshot 212. The instruction decode stage 118 thus generates an optimized corrected fetch path 322 in which the conditional non-branch instruction 320 is replaced by a NOP (no operation) instruction 324.

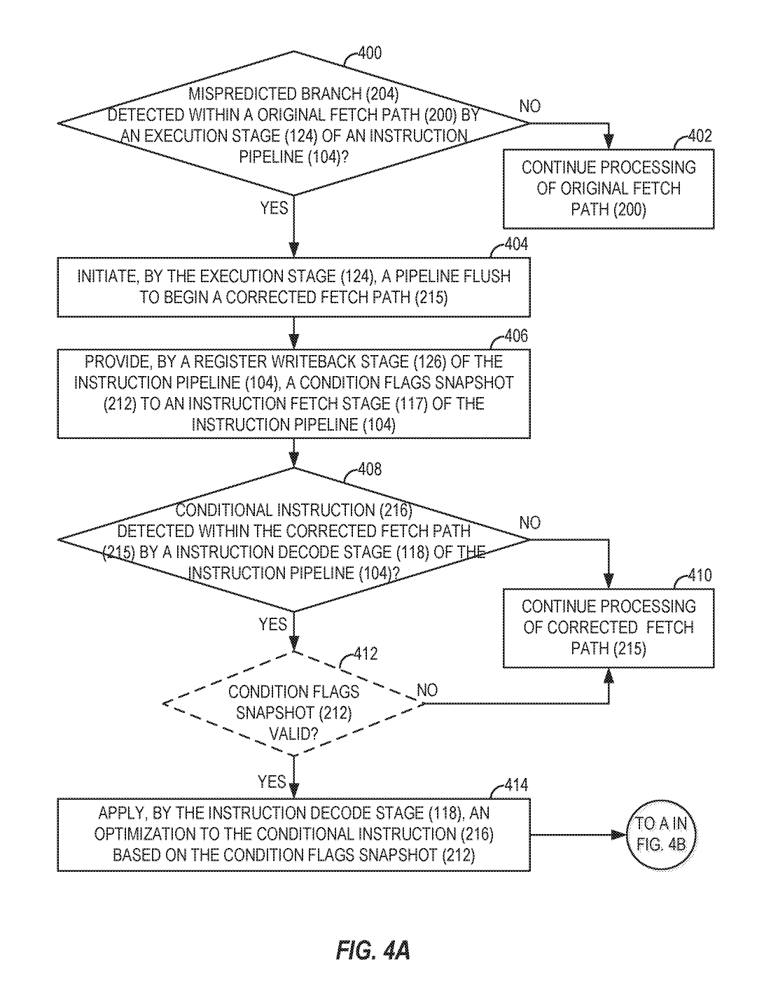

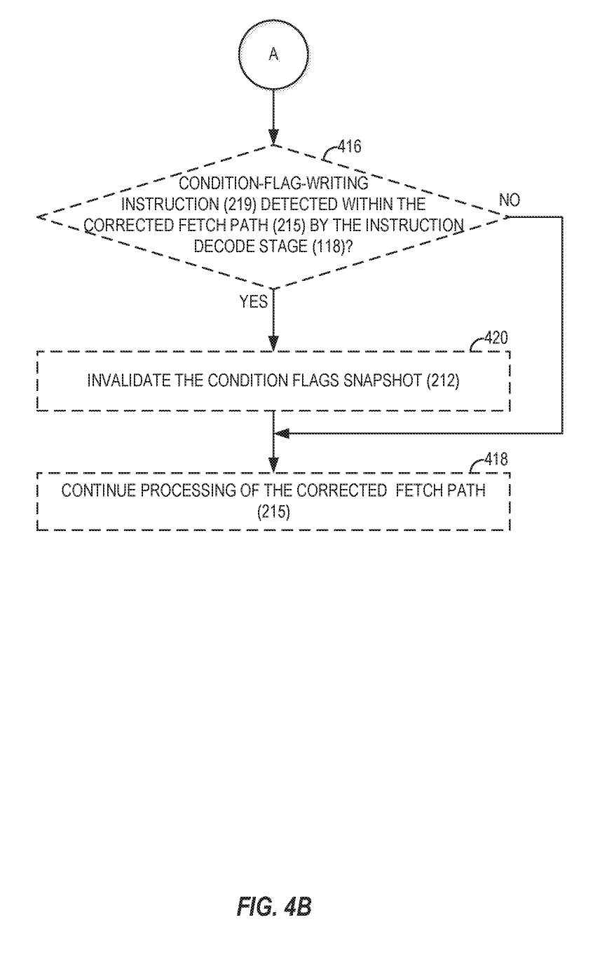

To illustrate exemplary operations for providing early pipeline optimization of conditional instructions in processor-based systems, FIGS. 4A and 4B are provided. For the sake of clarity, elements of FIGS. 1, 2, and 3A-3C are referenced in describing FIGS. 4A and 4B. Operations in FIG. 4A begin with an execution stage, such as the one or more execution stages 124 of the instruction pipeline 104 of FIG. 1, determining whether a mispredicted branch 204 is detected within the original fetch path 200 (block 400). In this regard, the one or more execution stages 124 of FIG. 1 may be referred to herein as “a means for detecting a mispredicted branch within an original fetch path of an instruction pipeline of the processor-based system.” If a mispredicted branch 204 has not been detected, processing of the original fetch path 200 continues (block 402). However, if the one or more execution stages 124 determine at decision block 400 that the mispredicted branch 204 is detected, the one or more execution stages 124 initiate a pipeline flush to begin the corrected fetch path 215 (block 404). Accordingly, the one or more execution stages 124 may be referred to herein as “a means for initiating a pipeline flush to begin a corrected fetch path, responsive to the mispredicted branch.”

The register writeback stage 126 of the instruction pipeline 104 then provides a condition flags snapshot 212 to an instruction fetch stage, such as the one or more instruction fetch stages 117, of the instruction pipeline 104 (block 406). The register writeback stage 126 thus may be referred to herein as “a means for providing a condition flags snapshot comprising a current state of one or more condition flags to an instruction fetch stage of the instruction pipeline.” The instruction decode stage 118 of the instruction pipeline 104 then determines whether a conditional instruction 216 is detected within the corrected fetch path 215 (block 408). In this regard, the instruction decode stage 118 may be referred to herein as “a means for detecting a conditional instruction within the corrected fetch path.” If no conditional instruction 216 is detected, processing of the corrected fetch path 215 continues (block 410). However, in some aspects, if the instruction decode stage 118 detects a conditional instruction 216 within the corrected fetch path 215 at decision block 408, the instruction decode stage 118 may next determine whether the condition flags snapshot 212 is valid (block 412). If the condition flags snapshot 212 is not valid, processing of the corrected fetch path 215 continues (block 410). If the condition flags snapshot 212 is valid, the instruction decode stage 118 applies an optimization to the conditional instruction 216 based on the condition flags snapshot 212 (block 414). Accordingly, the instruction decode stage 118 may be referred to herein as “a means for applying an optimization to the conditional instruction based on the condition flags snapshot.” Processing in some aspects then continues at block 416 of FIG. 4B.

Referring now to FIG. 4B, some aspects may provide that the instruction decode stage 118 determines whether a condition-flag-writing instruction 219 is detected within the corrected fetch path 215 (block 416). If not, processing of the corrected fetch path 215 continues (block 418). However, if the instruction decode stage 118 detects a condition-flag-writing instruction 219 at decision block 416, the instruction decode stage 118 invalidates the condition flags snapshot 212 (block 420). Processing of the corrected fetch path 215 then continues (block 418).

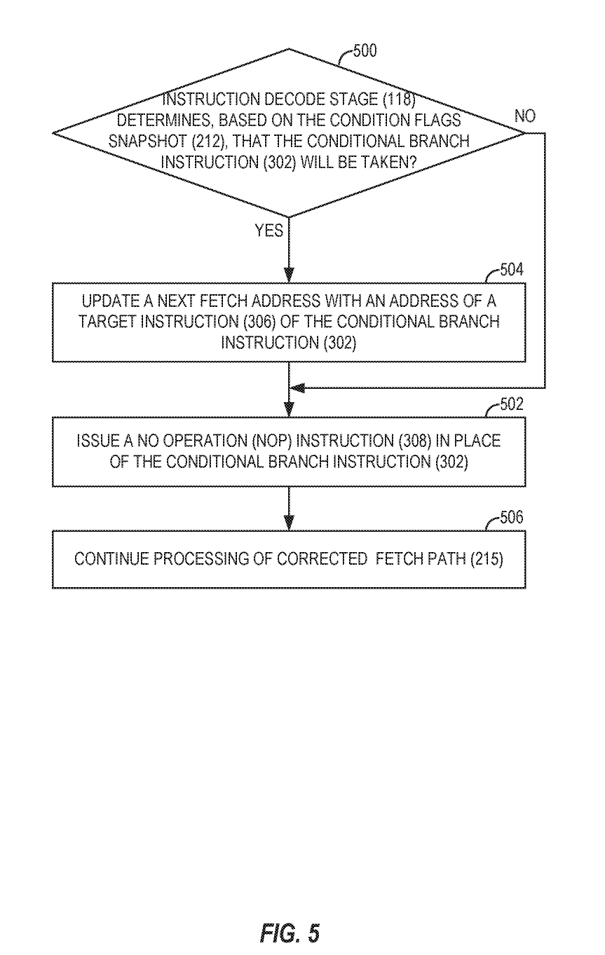

FIG. 5 further illustrates exemplary operations for applying optimizations to conditional branch instructions according to some aspects. It is to be understood that the operations illustrated in FIG. 5 correspond to the operation referenced in block 414 of FIG. 4A for applying an optimization to the conditional instruction 216 based on the condition flags snapshot 212. Elements of FIGS. 1, 2, and 3A-3C are referenced in describing FIG. 5 for the sake of clarity.

In FIG. 5, operations begin with the instruction decode stage 118 of the instruction pipeline 104 of FIG. 1 determining, based on the condition flags snapshot 212, whether the conditional branch instruction 302 will be taken (block 500). If not, processing of the corrected fetch path 215 continues at block 502. However, if the instruction decode stage 118 determines at decision block 500 that the conditional branch instruction 302 will be taken, the instruction decode stage 118 updates a next fetch address with an address of a target instruction 306 of the conditional branch instruction 302 (block 504). The instruction decode stage 118 then replaces the conditional branch instruction 302 with a NOP (no operation) instruction 308 (block 502). Processing of the corrected fetch path 215 then continues (block 506).

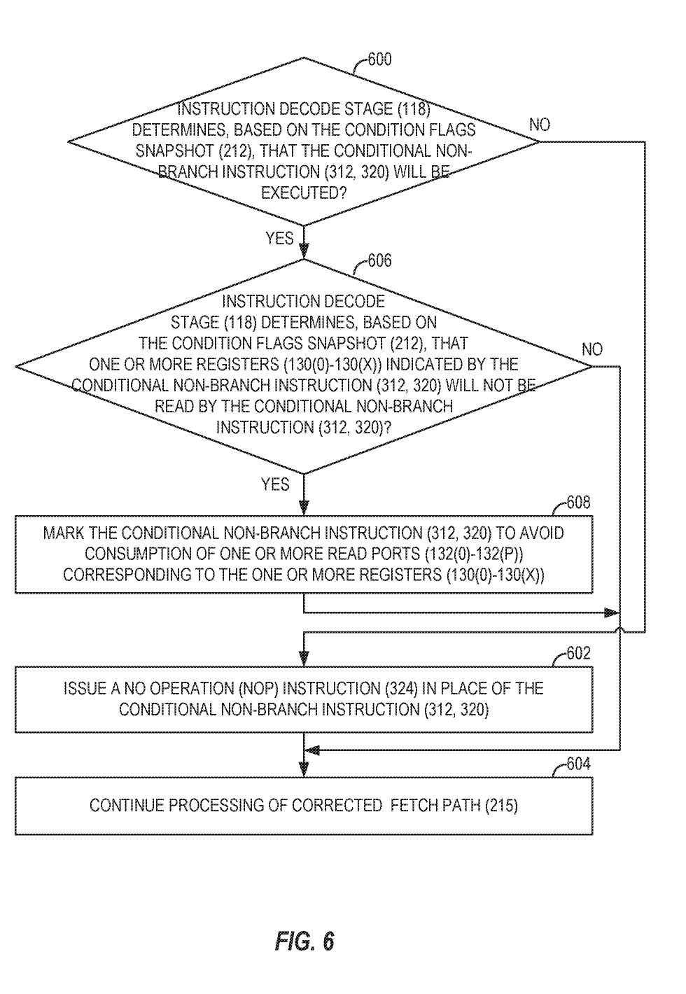

To illustrate exemplary operations for applying optimizations to conditional non-branch instructions according to some aspects, FIG. 6 is provided. It is to be understood that the operations illustrated in FIG. 6 correspond to the operation referenced in block 414 of FIG. 4A for applying an optimization to the conditional instruction 216 based on the condition flags snapshot 212. For the sake of clarity, elements of FIGS. 1, 2, and 3A-3C are referenced in describing FIG. 6. Operations in FIG. 6 begin with the instruction decode stage 118 determining, based on the condition flags snapshot 212, whether the conditional non-branch instruction 312, 320 will be executed (block 600). If not, the instruction decode stage 118 replaces the conditional non-branch instruction 312, 320 with a NOP (no operation) instruction 324 (block 602). Processing of the corrected fetch path 215 then continues (block 604).

If the instruction decode stage 118 determines at decision block 600 that the conditional non-branch instruction 312, 320 will be executed, the instruction decode stage 118 next determines, based on the condition flags snapshot 212, whether one or more registers 130(0)-130(X) indicated by the conditional non-branch instruction 312, 320 will not be read by the conditional non-branch instruction 312, 320 (block 606). If so, the instruction decode stage 118 marks the conditional non-branch instruction 312, 320 to avoid consumption of one or more read ports 132(0)-132(P) corresponding to the one or more registers 130(0)-130(X) (block 608). Processing of the corrected fetch path 215 then continues (block 604).

Providing early pipeline optimization of conditional instructions in process-based systems according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

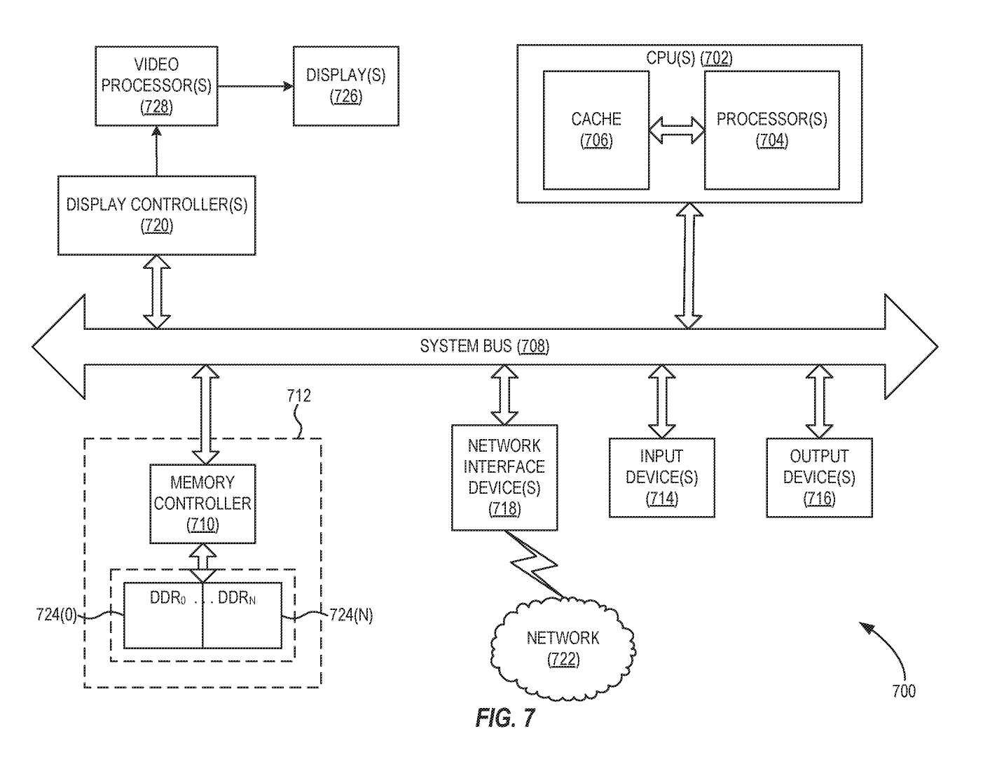

In this regard, FIG. 7 illustrates an example of a processor-based system 700 that can employ the instruction pipeline 104 illustrated in FIG. 1. The processor-based system 700 includes one or more CPUs 702, each including one or more processors 704 (which in some aspects may correspond to the processor 102 of FIG. 1). The CPU(s) 702 may have cache memory 706 coupled to the processor(s) 704 for rapid access to temporarily stored data. The CPU(s) 702 is coupled to a system bus 708 and can intercouple master and slave devices included in the processor-based system 700. As is well known, the CPU(s) 702 communicates with these other devices by exchanging address, control, and data information over the system bus 708. For example, the CPU(s) 702 can communicate bus transaction requests to a memory controller 710 as an example of a slave device.

Other master and slave devices can be connected to the system bus 708. As illustrated in FIG. 7, these devices can include a memory system 712, one or more input devices 714, one or more output devices 716, one or more network interface devices 718, and one or more display controllers 720, as examples. The input device(s) 714 can include any type of input device, including but not limited to input keys, switches, voice processors, etc. The output device(s) 716 can include any type of output device, including, but not limited to, audio, video, other visual indicators, etc. The network interface device(s) 718 can be any devices configured to allow exchange of data to and from a network 722. The network 722 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 718 can be configured to support any type of communications protocol desired. The memory system 712 can include one or more memory units 724(0)-724(N).

The CPU(s) 702 may also be configured to access the display controller(s) 720 over the system bus 708 to control information sent to one or more displays 726. The display controller(s) 720 sends information to the display(s) 726 to be displayed via one or more video processors 728, which process the information to be displayed into a format suitable for the display(s) 726. The display(s) 726 can include any type of display, including, but not limited to, a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A processor-based system for providing early pipeline optimization of conditional instructions, comprising an instruction pipeline comprising an instruction fetch stage, an instruction decode stage, an execution stage, and a register writeback stage;
the execution stage of the instruction pipeline configured to:
detect a mispredicted branch within an original fetch path; and
responsive to the mispredicted branch, initiate a pipeline flush to begin a corrected fetch path;
the register writeback stage of the instruction pipeline configured to, responsive to the mispredicted branch, provide a condition flags snapshot comprising a current state of one or more condition flags to the instruction fetch stage of the instruction pipeline; and
the instruction decode stage of the instruction pipeline configured to:
detect a conditional instruction within the corrected fetch path; and
apply an optimization to the conditional instruction based on the condition flags snapshot.

2. The processor-based system of claim 1, wherein:
the conditional instruction comprises a conditional branch instruction; and
the instruction decode stage of the instruction pipeline of the processor-based system is configured to apply the optimization to the conditional instruction based on the condition flags snapshot by being configured to:
determine, based on the condition flags snapshot, that the conditional branch instruction will be taken; and
responsive to determining that the conditional branch instruction will be taken:
update a next fetch address with an address of a target instruction of the conditional branch instruction; and
replace the conditional branch instruction with a NOP (no operation) instruction.

3. The processor-based system of claim 1, wherein:
the conditional instruction comprises a conditional non-branch instruction; and
the instruction decode stage is configured to apply the optimization to the conditional instruction based on the condition flags snapshot by being configured to:
determine, based on the condition flags snapshot, that the conditional non-branch instruction will be executed; and
responsive to determining that the conditional non-branch instruction will be executed:
determine, based on the condition flags snapshot, that one or more registers indicated by the conditional non-branch instruction will not be read by the conditional non-branch instruction; and
mark the conditional non-branch instruction as a marked unconditional non-branch instruction to avoid consumption of one or more read ports corresponding to the one or more registers.

4. The processor-based system of claim 1, wherein:
the conditional instruction comprises a conditional non-branch instruction; and
the instruction decode stage is configured to apply the optimization to the conditional instruction based on the condition flags snapshot by being configured to:
determine, by the instruction fetch stage based on the condition flags snapshot, that the conditional non-branch instruction will not be executed; and
responsive to determining that the conditional non-branch instruction will not be executed, replace the conditional non-branch instruction with a NOP (no operation) instruction.

5. The processor-based system of claim 1, wherein the instruction decode stage is configured to apply the optimization to the conditional instruction based on the condition flags snapshot responsive to determining that the condition flags snapshot is valid.

6. The processor-based system of claim 5, wherein the instruction decode stage is further configured to:
detect a condition-flag-writing instruction within the corrected fetch path; and
responsive to detecting the condition-flag-writing instruction within the corrected fetch path, invalidate the condition flags snapshot.

7. The processor-based system of claim 1 integrated into an integrated circuit (IC).

8. The processor-based system of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device (e.g., a smart watch, a health or fitness tracker, eyewear, etc.); a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

9. A processor-based system for providing early pipeline optimization of conditional instructions, comprising:
a means for detecting a mispredicted branch within an original fetch path of an instruction pipeline of the processor-based system;
a means for initiating a pipeline flush to begin a corrected fetch path, responsive to the mispredicted branch:
a means for providing a condition flags snapshot comprising a current state of one or more condition flags to an instruction fetch stage of the instruction pipeline;
a means for detecting a conditional instruction within the corrected fetch path; and
a means for applying an optimization to the conditional instruction based on the condition flags snapshot.

10. A method for providing early pipeline optimization of conditional instructions, comprising:
detecting, by an execution stage of an instruction pipeline, a mispredicted branch within an original fetch path;
responsive to the mispredicted branch:
initiating, by the execution stage, a pipeline flush to begin a corrected fetch path; and
providing, by a register writeback stage of the instruction pipeline, a condition flags snapshot comprising a current state of one or more condition flags to an instruction fetch stage of the instruction pipeline;
detecting, by an instruction decode stage of the instruction pipeline, a conditional instruction within the corrected fetch path; and
applying, by the instruction decode stage, an optimization to the conditional instruction based on the condition flags snapshot.

11. The method of claim 10, wherein:
the conditional instruction comprises a conditional branch instruction; and
applying the optimization to the conditional instruction based on the condition flags snapshot comprises:
determining, by the instruction decode stage based on the condition flags snapshot, that the conditional branch instruction will be taken; and
responsive to determining that the conditional branch instruction will be taken:
updating a next fetch address with an address of a target instruction of the conditional branch instruction; and
replacing the conditional branch instruction with a NOP (no operation) instruction.

12. The method of claim 10, wherein:
the conditional instruction comprises a conditional non-branch instruction; and
applying the optimization to the conditional instruction based on the condition flags snapshot comprises:
determining, by the instruction decode stage based on the condition flags snapshot, that the conditional non-branch instruction will be executed; and
responsive to determining that the conditional non-branch instruction will be executed:
determining, by the instruction decode stage based on the condition flags snapshot, that one or more registers indicated by the conditional non-branch instruction will not be read by the conditional non-branch instruction; and
marking the conditional non-branch instruction as a marked unconditional non-branch instruction to avoid consumption of one or more read ports corresponding to the one or more registers.

13. The method of claim 10, wherein:
the conditional instruction comprises a conditional non-branch instruction; and
applying the optimization to the conditional instruction based on the condition flags snapshot comprises:
determining, by the instruction decode stage based on the condition flags snapshot, that the conditional non-branch instruction will not be executed; and
responsive to determining that the conditional non-branch instruction will not be executed, replacing the conditional non-branch instruction with a NOP (no operation) instruction.

14. The method of claim 10, wherein applying the optimization to the conditional instruction based on the condition flags snapshot is responsive to determining that the condition flags snapshot is valid.

15. The method of claim 14, further comprising:
detecting, by the instruction decode stage, a condition-flag-writing instruction within the corrected fetch path; and
responsive to detecting the condition-flag-writing instruction within the corrected fetch path, invalidating the condition flags snapshot.

16. A non-transitory computer-readable medium having stored thereon computer-readable instructions to cause a processor to:
detect a mispredicted branch within an original fetch path of an instruction pipeline of the processor;
responsive to the mispredicted branch:
initiate a pipeline flush to begin a corrected fetch path; and
provide a condition flags snapshot comprising a current state of one or more condition flags to an instruction fetch stage of the instruction pipeline;
detect a conditional instruction within the corrected fetch path; and
apply an optimization to the conditional instruction based on the condition flags snapshot.

17. The non-transitory computer-readable medium of claim 16, wherein:
the conditional instruction comprises a conditional branch instruction; and
the computer-readable instructions causing the processor to apply the optimization to the conditional instruction based on the condition flags snapshot comprise computer-readable instructions causing the processor to:
determine, based on the condition flags snapshot, that the conditional branch instruction will be taken; and
responsive to determining that the conditional branch instruction will be taken:
update a next fetch address with an address of a target instruction of the conditional branch instruction; and
replace the conditional branch instruction with a NOP (no operation) instruction.

18. The non-transitory computer-readable medium of claim 16, wherein:
the conditional instruction comprises a conditional non-branch instruction; and
the computer-readable instructions causing the processor to apply the optimization to the conditional instruction based on the condition flags snapshot comprise computer-readable instructions causing the processor to:
determine, based on the condition flags snapshot, that the conditional non-branch instruction will be executed; and
responsive to determining that the conditional non-branch instruction will be executed:
determine, based on the condition flags snapshot, that one or more registers indicated by the conditional non-branch instruction will not be read by the conditional non-branch instruction; and
mark the conditional non-branch instruction as a marked unconditional non-branch instruction to avoid consumption of one or more read ports corresponding to the one or more registers.

19. The non-transitory computer-readable medium of claim 16, wherein:
the conditional instruction comprises a conditional non-branch instruction; and
the computer-readable instructions causing the processor to apply the optimization to the conditional instruction based on the condition flags snapshot comprise computer-readable instructions causing the processor to:
determine, based on the condition flags snapshot, that the conditional non-branch instruction will not be executed; and
responsive to determining that the conditional non-branch instruction will not be executed, replace the conditional non-branch instruction with a NOP (no operation) instruction.

20. The non-transitory computer-readable medium of claim 16, wherein the computer-readable instructions causing the processor to apply the optimization to the conditional instruction based on the condition flags snapshot comprise computer-readable instructions causing the processor to apply the optimization to the conditional instruction based on the condition flags snapshot responsive to determining that the condition flags snapshot is valid.

21. The non-transitory computer-readable medium of claim 20, further comprising computer-readable instructions to cause the processor to:
detect a condition-flag-writing instruction within the corrected fetch path; and
responsive to detecting the condition-flag-writing instruction within the corrected fetch path, invalidate the condition flags snapshot.
